(19) United States
(12) Patent Application Publication
(10) Pub. No.: US 2005/0194218 A1
(43) Pub. Date: Sep. 8, 2005

(54) Hand deactivated shopping cart automatic braking system

(76) Inventor: Paul Thomas D'Arca, Riverside, CA (US)

Correspondence Address: SNELL & WILMER LLP, 1920 MAIN STREET, SUITE 1200, IRVINE, CA, 92614-7230, US

(21) Appl. No.: 10/794,622

(22) Filed: Mar. 8, 2004

(51) Int. Cl. B62B 5/04

(52) U.S. Cl. 188/19

(57) ABSTRACT

A braking system designed to be an integral part of a shopping cart. The braking system consists of a hand-operated brake that is normally engaged. The user disengages the braking system to move the shopping cart. The braking system is also disengaged when the shopping cart is nested with other shopping carts to allow multiple carts to be moved without the brakes being engaged. The mechanical link from the handle to the brake is enclosed within the frame to reduce potential damage to the mechanism. The mechanical link consists of a hand-activated handle that is pushed down to disengage the brake, and when the handle is not depressed, the handle raises by gravity and applies the brake.

### BACKGROUND OF THE INVENTION

Field of the invention relates to a braking system used in a shopping cart. More specifically, a shopping cart with a brake that must be disengaged by the operator to allow movement of the shopping cart. The invention also discloses that when the shopping cart is nested with other carts the braking system is also disengaged to allow multiple shopping carts to be moved.

Shopping carts are convenient transportation devices that are used when one or multiple items are purchased at a store. Most commercially available shopping carts do not employ a braking system in the shopping cart. One problem with currently available shopping carts is that they can roll away if the cart is placed on a slope. Many of people at one time or another have had a shopping cart roll away, or have seen a shopping cart roll down a parking area and stop when the shopping cart comes in contact with a car or other object. The ideal shopping cart would provide the convenience of easy mobility when we in use and sufficient braking capacity when the cart is not being pushed or moved. The ideal design would need to be rugged enough to withstand the daily use and pounding imposed on today's shopping carts, and provide safety to the user so a finger and clothing is not pinched by the mechanism. Simplicity of the design of the shopping cart is important for manufacturing, user understanding, longevity of the mechanism and the braking surfaces. Several inventions have tried to produce a shopping cart with these features.

U.S. Pat. Nos. 4,018,449, 5,325,938, 5,735,367 utilize a cable running either inside a tube, or inside a sheath that is connected to a tube on the shopping cart to manipulate the brake that is applied to the wheel. U.S. Pat. Nos. 2,958,537, 3,095,211, 3,501,164, 4,840,388, 4,976,447, 5,499,697, 6,199,878 use a rod located outside the frame tube of the shopping cart. All these prior patents provide the link from the handle to the brake, but the linking mechanism is fragile, and subject to intentional or unintentional damage. What is needed is a linkage from the handle to the braking mechanism is that solid, and protected.

Another valuable attribute of the invention is that the operation of the braking mechanism should be easy to use and operate. The method of de-activating the brake should be the same as using the shopping cart. U.S. Pat. Nos. 2,958,537, 5,499,697 require the user to lift the handle to deactivate the brake. U.S. Pat. No. 6,199,878 require the user to rotate the handle. U.S. Pat. No. 4,976,447 require the user to pull the handle. U.S. Pat. No. 4,840,388 requires the user to grasp or squeeze the handle. None of the listed patents requires the user to perform the function of pushing the cart to deactivate the brake, or resting on the handle as the cart is being pushed. In addition, most of the designs require the user to overcome a spring that keeps the handle and or the brake engaged.

Still another valuable attribute of the invention would involve a braking system that does not reduce the life of the tires on the shopping cart. U.S. Pat. Nos. 3,095,211, 3,501,164, 4,018,449, 4,840,388, 4,976,447, 5,325,938, 5,499,697 5,735,367 and 6,199,878 utilize a braking system that rubs on at least a part of one tire of the shopping cart. U.S. Pat. No. 2,958,537 uses a pawl that engages in a ratchet tooth, and when the pawl is engaged, the wheel is locked into position causing the tire to slide on the ground. What is needed is a braking system that does not abraded the tire to cause the braking of the shopping cart.

While the prior art provides the basic function of slowing or stopping a shopping cart, none of the prior art provided a braking system that disengaged the braking system while the cart is being pushed, where the connecting rod is protected from normal and abnormal damage, or the braking system does not abrade the tire surface. The disclosed invention provides unique solutions to each of these previously undisclosed combined improvements.

### BRIEF SUMMARY OF THE INVENTION

It is therefore an object of the present invention to provide improvements to prior shopping cart mechanisms and methods.

The invention consists of a braking system that can be attached or is an integral part of a shopping cart. The shopping cart can be any type of cart that contains a basket for transporting items, has three or more wheels, and a handle or area that is pushed by the operator. The invention provides for a number of improvements that provide additional benefits and improved features for existing shopping carts.

It is a feature of the present invention to provide an improvement to prior shopping cart designs that allow for a braking system that is rugged, user friendly, and does not abrade the tire surface. The improvements also allow for an improvement in the disengagement mechanism that releases the braking mechanism when multiple carts are nested.

Advantages of the de-activation mechanism allows for the brake(s) to be released when the cart is pushed or when the user presses down on the handle. This is advantageous for use because new users may not be familiar with the operation of the mechanism, and any improvement to shopping cart design should allow users to operate the shopping cart in a manner they would normally operate the cart. It is a further advantage to experienced users that may rest on the handle as they push the cart in a store.

It is a further advantage to use a rugged or protected mechanical link from the handle to the brake is to reduce or eliminate damage to the mechanism should the shopping cart be damage from normal or abnormal use. Damage can be caused from carts being nested, struck by cars, or users trying to bend fragile parts. Many previously identified inventions are not designed to reduce the potential of damage.

Advantages of the disclosed braking system do not impact the life of the wheel. The disclosed braking system provides a positive braking system that locks or slows the tire, and brings the cart to a stop. In a number of prior braking systems, a user may not be able to see the braking mechanism, or the user might not be able to determine if the brakes are activated, or if the cart just has a bad wheel. The tooth and cog mechanism is more visible to the user because the mechanism is located on the side of the wheel

Other preferred aspects of the present invention will become clear from the detailed description herein described below.

### BRIEF DESCRIPTION OF THE DRAWINGS

FIG. 1 is an isometric view of a shopping cart with the invention installed.

FIG. 2 is a detailed view of one embodiment of the handle mechanism

FIG. 3 is an alternate embodiment of the handle mechanism.

FIG. 4 is a detailed view of one embodiment of the braking mechanism.

FIG. 5 is an alternate embodiment of the braking mechanism.

### DETAILED DESCRIPTION OF THE INVENTION

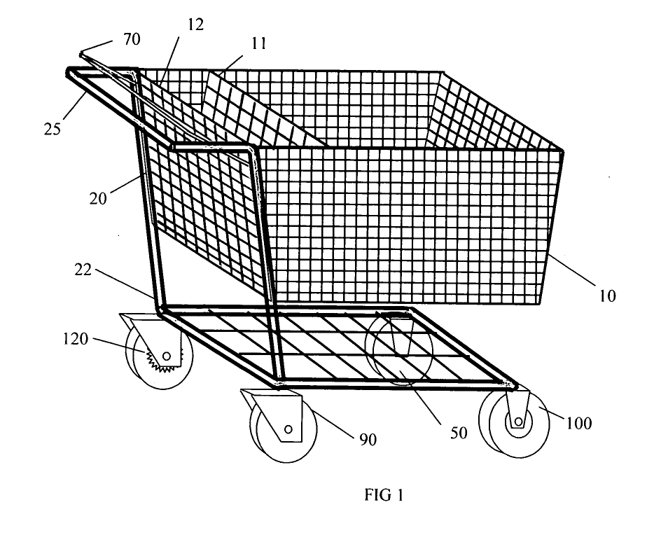

Refer first to FIG. 1 that represents an isometric view of the preferred embodiment where the mechanism is shown on a shopping cart. The basket 10 represents the area where a user may place items they wish to transport in the shopping cart. The shopping cart basket can be made from a variety of materials including metal wire, metal tubing, expanded metal, molded plastics, or any other material that is capable of creating an open structure where items can be placed for transportation. The basket may also be formed from a solid material that allows the basket to hold liquid, granulated or powdered material. The shape of the basket consists of four sides, and a bottom surface. While the preferred embodiment is rectangular, other shapes are contemplated including round, elliptical, or a flat plate or screen with shortened or no sides. The material the basket is made from may be coated, plated or colored for appearance or for wear or corrosion resistance. The method of manufacturing the basket can be from molding, welding, bending or other type of manufacturing method that allows for the creation of the basket shape. The basket may consist of multiple baskets or basket areas. The basket may have a divider, item 11, and shelf where a user can place one or more children, or a purse of bag that they do not want to place with the item they may purchase. In FIG. 1, the rear wall, item 12 can be rotated up to allow for nesting of multiple carts. In yet another embodiment the entire basket can rotate into a vertical orientation to allow for nesting of carts.

Item 20 is the structural frame that creates the strength for the shopping cart. The frame links the front pivoting or turning wheels, item 100, the fixed rear wheels, item 90, the undercarriage, item 50, to the basket, item 10, and then to the handle of the shopping cart, item 25. The structural frame can be made from a variety of materials including round or square metal tubing, molded or formed plastics, or any other material that is capable of providing structural strength and linking the identified components. The shape of the structural frame can vary significantly. The preferred embodiment is shown, but varieties of shapes are possible, including a shape where the undercarriage does not exist. In another embodiment, the shopping cart may consist of multiple baskets or multiple shelves where different items can be located. In the preferred embodiment the vertical frame member(s), item 22 are straight, and run from the handle are down to the rear wheels. Alternate embodiments for the rear members include “S” or 30 “L” shaped members where the member slants forward from the handle 25, and the bends back to the rear wheel. The forward slant is made to provide area for the person to move their legs as they walk and push the cart. The bend is made to bring the wheels further back so the cart does not tip back if a heavy child is placed in the rear of the cart. If the rear tube is not straight, a secondary tube can be used to protect the connecting of an activation rod from the articulating handle, shown as item 70 to the braking mechanism. A portion of the braking mechanism can be seen in this figure as 120 connected to a rear fixed tire item 90.

The under carriage, item 50 is an open are for storing items, a secondary purpose of the undercarriage is to provide a nesting area for the undercarriage of a second cart that may be nested. In the preferred embodiment, the structural frame consists of tube that extends from the rear of the cart to the front of the cart. As the tube transitions from the back to the front of the cart, the tube narrows to allow for nesting of additional carts. In another embodiment of the tube, the tube angles up or down as it transitions from the back to the front of the cart to allow for nesting of multiple carts.

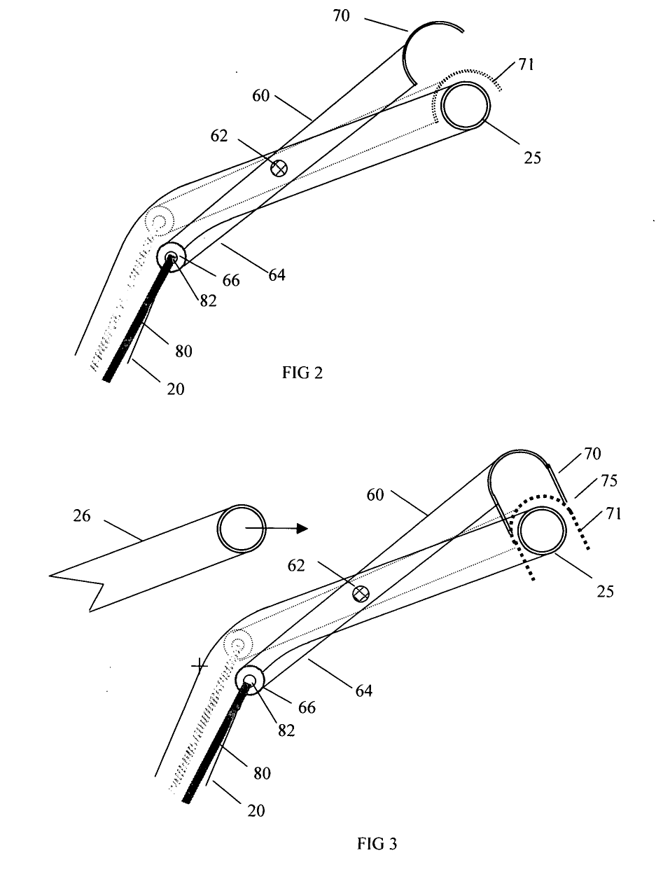

Refer now to FIG. 2 that show the preferred embodiment of the structural frame handle, item 25, and the articulating handle item 70. The articulating handle, item 70, is shown in the up position as item 70, and in the down position as item 71. In this embodiment, as the handle is pressed down the brake is disengaged. The handle can be formed from wire, sheet metal or molded from plastic or similar material. The articulating handle is connected to a pivoting arm, item 60. The pivoting art pivots about pivot point 62 such that when the articulating handle is depressed, the back of the pivot arm is lifted, item 64. The pivot point consists of a hole in the pivot arm connected by a suitable bearing mechanism such as a shoulder bolt or similar mechanism. As the rear part of the pivot arm is lifted, the pivot arm lifts the linkage rod item 80. The linkage rod 80 is shown enclosed within the frame of the shopping cart in FIG. 1. While the tube that protects the link is shown as a part of the frame, the protection tube could be a separate member that is not part of the structural frame. The linkage rod is connected to the back end of the articulating lever with a simple mechanical linkage consisting of a hole, 66 in the pivot arm, and a bend in the linkage rod, item 82. The end of the bent section of linkage rod 82 may be terminated with a cotter pin, speed nut or similar device. The termination may also be formed from a flat that is crushed onto the end of the linkage rod.

Refer now to FIG. 3 that show an alternate embodiment. In this embodiment, the articulating handle item 70 is shown as a member with elongated sides covering for the handle item 25. In the raised position, the end of the articulating handle, item 75, is about tangent with the end on the handle. When the articulating handle is depressed as shown as item 71 the elongated sides of the handle moves over the frame handle. In this configuration a potential pinch point between the handle 25 and the articulating handle, item 70 is reduced. The linkage rod 80 runs within, or along the side or the structural frame. The linkage rod may also run within a portion of the frame. The linkage rod may also run within a secondary tube. The linkage rod continues down a tube and terminates at the braking mechanism. The weight of the linkage rod maintains the articulating handle in the up position and brake in an activated position.

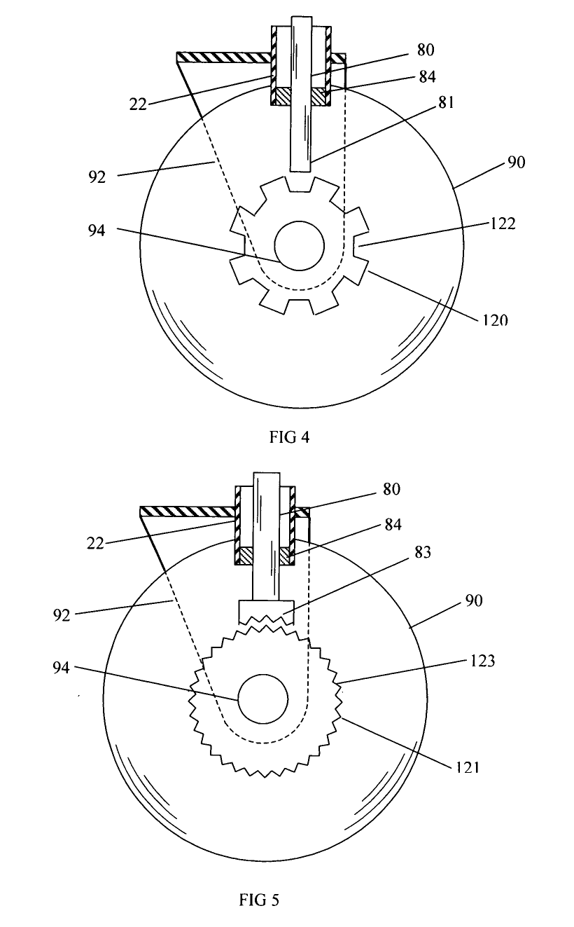

Refer now to FIG. 4, which show the braking mechanism. In this embodiment the linkage rod, item 80 is shown extending through the bottom of the vertical member of the structural frame item 22. As the linkage rod exits the structural frame a guide bushing, item 84 is used to keep the linkage rod in position. The material used in the braking gear, item 120 can be metal or plastic. In the preferred embodiment, the braking gear is made from a metallic material due to the potential high loads the brakes may encounter if the basket is full of heavy items, or if the cart is moving quickly when the brakes are engaged. In this embodiment, the gear consists of raised teeth and depressions where the end of the linkage rod, item 81 engages. When the linkage rod engages into the gear the tire is prevented from turning. The gear can be connected to or be an integral part of the tire item 90. The tire and gear is supported by a bearing or hub, item 94. The hub item 94 is connected to a support member, 92. The support member 92 is then connected to the vertical frame member, item 22. From this figure, it can be seen that when the linkage rod is lifted the braking mechanism is disengage. When the linkage rod is lowered, the tip of the linkage rod, item 81 engages into at least one tooth item 122 of the braking gear item 120. In this embodiment, gravity is capable of holding brake engaged, and the invention does not require a spring to hold the brake in place. The user must simply overcome the force of gravity upon the linkage rod and any frictional losses in the pivot and sliding mechanisms.

FIG. 5 shows an alternate embodiment of the invention. In this embodiment, the end of the linkage rod has a gear tooth, item 83, connected. The gear attached to the wheel is shown as item 121. In this configuration, when item 83 is brought into contact with a featured member item 121 the wheel does not come to a stop, but the wheel will turn with intermittent braking action. The gear is a member with features on the peripheral edge that provides braking action. The featured member may consist of a semi-round member, where the feature consists of square teeth, unidirectional teeth, triangular teeth, or one or more rounded lobes. Unidirectional teeth would allow limited breaking of the wheel in one direction and full breaking of the wheel in the opposite direction. The intermittent braking is caused by the teeth, item 123 of the gears meshing, and then skipping teeth. The braking gear may consist of multiple rounded teeth. In this embodiment, the braking system provides limited breaking of the cart. An advantage of this embodiment is that the shopping cart can still be moved without dragging the wheel. Another advantage is that if the user tries to operate the cart without disengaging the brake the cart will have variable breaking. One or multiple lobs can be utilized. In addition, the configuration of the lobs can be adjusted using a follower in a lobed cam, to provide just a single breaking action for each revolution of the wheel to hundreds or more discreet braking positions per revolution of the wheel. The follower can be a bearing, or self-lubricating material such as Teflon. The end of the linkage rod, item 83 may be a follower consisting of a bearing that rides up and down on the outer surface of the featured member, item 122. In this figure, 32 lobes are shown. In yet another advantage of this configuration no abrasion of the wheel occurred, since the lob rolls over the cam, teeth on gear.

Refer back to FIG. 3 where you can see the handle from a second cart, item 26. When a second cart is being nested, the handle for a second cart slides against the pivoting member, item 60, of the handle on the first cart and depressed the pivoting member and articulating handle of the first cart.

Thus, specific embodiments and applications for a braking system for a shopping cart have been disclosed. It should be apparent, however, to those skilled in the art that many more modifications besides those described are possible without departing from the inventive concepts herein. For example, the shopping braking mechanism may be activated to the front wheels, or the braking system may be located on both sides of the wheel. The braking system may also apply the brakes by pressing a pin into a detail of the tire on the shopping cart such a holes placed on the periphery of the tire. The inventive subject matter, therefore, is not to be restricted except in the spirit of the appended claims.

1. A shopping cart with a hand activated wheel braking mechanism comprising:
a structural frame connecting an open basket section consisting of a bottom and at least one side wall, and
a handle located at one side of the basket, and
at least three wheels rotationally connected to the structural frame located below the corners of the basket, and
a lever pivotally connected to the structural frame whereby when the lever is operated the lever moves a mechanical link connected to the handle, and
the opposite end of the mechanical link disengages a braking system consisting of a cog that within a gear located on at least one of the wheels.

2. The shopping cart of claim 1 where the basket shape is selected from the group of trapezoidal, square, triangular, and round.

3. The shopping cart of claim 1 where the material of the shopping cart is selected from a material of metal, plastic, glass, and a combination of these materials.

4. The shopping cart from claim 1 further includes that the braking mechanism is disengaged when multiple carts are nested.

5. The lever from claim 1, wherein the lever can be rotated downward, forward, or upward.

6. The mechanical link from claim 1 where the link consists of a solid rod, flexible cable, chain linkage, or similar mechanical linkage.

7. The cog from claim 1 where the cog is a pin, blade, tooth or pinion.

8. The gear from claim 1 where the gear has at least one tooth or lob.

9. The lever from claim 1 wherein the lever covers at least a portion of the structural frame.

10. A shopping cart with a hand activated wheel braking mechanism comprising:
a structural frame connecting an open basket section consisting of a bottom and at least one side, and
a handle located at one side of the basket, and
at least three wheels rotationally connected to the structural frame located below the corners of the basket, and
a lever pivotally connected to the structural frame whereby when the lever is operated the lever moves a mechanical link connected to the handle, and
the opposite end of the mechanical link disengages a braking system consisting of follower that engages in a cam located on at least one of the wheels.

11. The shopping cart from claim 10 further includes that the braking mechanism is disengaged when multiple carts are nested.

12. The shopping cart of claim 10 where the material of the shopping cart is selected from a material of metal, plastic, glass, and a combination of these materials

13. The lever from claim 10 wherein the lever can be rotated downward, forward, or upward.

14. The mechanical link from claim 10 where the link consists of a solid rod, flexible cable, chain linkage, or similar mechanical linkage.

15. The pivotal connection from claim 10 wherein the pivotal connection is a hole within the lever.

16. The follower from claim 10 where the follower is a bearing.

17. The lever from claim 10 wherein the lever covers at least a portion of the structural frame.

18. A method of slowing a shopping cart comprising:
releasing a weighted rod to a featured member located on at least one wheel of the shopping cart.

19. The featured member of claim 18 consists of a cam and follower mechanism.

20. The release from claim 18 consists of the user not being in contact with the shopping cart.
